(19) United States
(12) Patent Application Publication
(10) Pub. No.: US 2008/0271241 A1
(43) Pub. Date: Nov. 6, 2008

(54) GLIDER CHAIR

(76) Inventors: Alan L. Tholkes, Burnsville, MN (US); DuWayne Dandurand, Belle Plaine, MN (US)

Correspondence Address: Leffert Jay & Polglaze, P.A., P.O. Box 581009, Minneapolis, MN, 55458-1009, US

(21) Appl. No.: 12/113,534

(22) Filed: May 1, 2008

Related U.S. Application Data
(60) Provisional application No. 60/916,095, filed on May 4, 2007.

(51) Int. Cl. A47C 3/40; A61G 5/08; A61G 5/00; A47C 17/76; A47C 1/00

(52) U.S. Cl. 5/11; 297/16.1; 297/258.1; 297/219.1

(57) ABSTRACT

A chair for assistance in sexual intercourse is a gliding type rocker chair that has adjustable length legs, seat angle adjustment, an easily removable seat cover, and is foldable for storage. A cot for use with or without the chair is also foldable, with adjustable length legs and angular adjustment, and an easily removable cot cover.

### RELATED APPLICATION

This application claims the benefit of U.S. Provisional Application No. 60/916,095, filed on May 4, 2007, hereby incorporated herein in its entirety by reference.

### FIELD

The present disclosure relates generally to assisting the physically challenged and in particular the present disclosure relates to assisting in intimate encounters for the physically challenged.

### BACKGROUND

Intimate relations including intercourse can be very difficult if either or both participants in an encounter have physical limitations. Such limitations include those individuals with traumatic injuries that result in paraplegia or quadriplegia, those individuals with severe back or joint pain, arthritis, obese individuals, individuals with little or no strength or stamina for any number of reasons, senior citizens, or the like. In many such instances, the limitations make intimate acts difficult or even impossible.

Previous devices and apparatuses have been designed to assist physically challenged individuals in intercourse and intimate relations. However, typical devices and apparatuses are unwieldy, large, cumbersome, and intrusive, often relying on elaborate gearing and moving parts as in U.S. Pat. No. 5,385,154; 6,135,552; or 6,698,431 for example, or are too simple to allow for a wider variety of positional changes and motions as in U.S. Pat. No. 7,018,329 and US Published Application US2003/0140926.

Further, large and cumbersome devices and apparatuses can be heavy and difficult to move, and may in fact be too complicated and require too much effort even to begin use, much less use the devices for their intended purpose. Also, large devices require large amounts of space and cannot easily be stored out of sight. One example of an attempt to provide a storable foldable device is in U.S. Pat. No. 5,538,011, but it too is quite clinical and not easily adjustable. Still further, this apparatus is nearly completely static, and requires more effort at movement than many physically challenged individuals can make.

For the reasons stated above, and for other reasons stated below which will become apparent to those skilled in the art upon reading and understanding the present specification, there is a need in the art for a discreet, functional intercourse assistance chair.

### SUMMARY

In one embodiment, a chair for assisting sexual intercourse includes a frame having adjustable height legs, a seat having a back support and a main support, the seat glidably supported by the frame to move in a substantially horizontal motion. The seat has a depth in one embodiment that is suitably short that while it provides support, the depth is small enough that intercourse can be engaged without undue strain.

In another embodiment, the seat has a removable seat pad, and the pad removable without disassembling the chair. Further, in another embodiment, a cot is included. The cot in one embodiment is on a foldable frame, the frame having adjustable height legs, and a cot support pad is removably mounted to the frame. The cot support pad is removable without disassembling the cot.

In another embodiment, the chair and the cot are each foldable and storable, so that they may be easily stored and transported.

Other embodiments are described and claimed.

### BRIEF DESCRIPTION OF DRAWINGS

FIG. 1 is an isometric view of a chair according to one embodiment of the present invention;

FIG. 2 is a closeup view of a portion of the chair of FIG. 1;

FIG. 3 is a side elevation of a chair such as that shown in FIG. 1 in a folded position;

FIG. 4 is an isometric view of a cot according to another embodiment of the present invention; and

FIG. 5 is a side elevation view of a chair and a cot in one configuration of a use position.

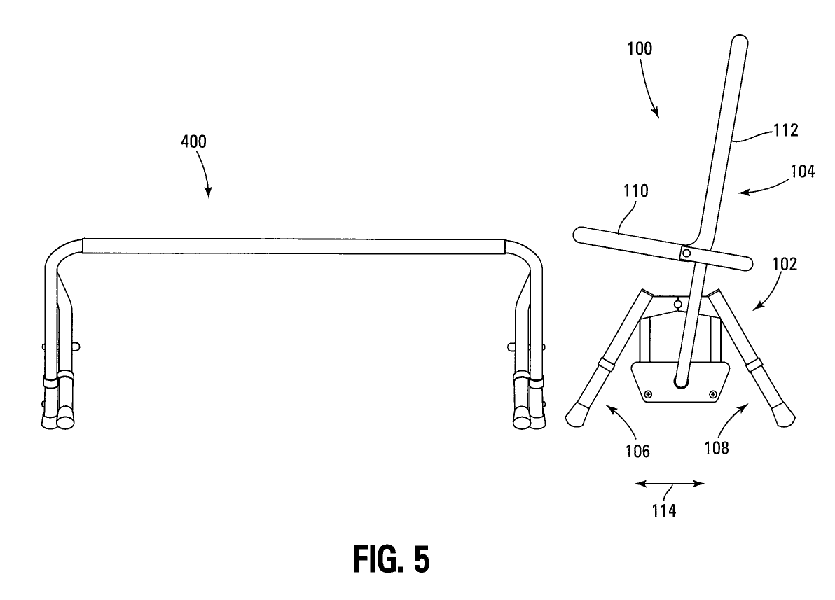

### DETAILED DESCRIPTION

In the following detailed description of the embodiments, reference is made to the accompanying drawings that form a part hereof. In the drawings, like numerals describe substantially similar components throughout the several views. These embodiments are described in sufficient detail to enable those skilled in the art to practice the invention. Other embodiments may be utilized and structural changes may be made without departing from the scope of the present invention.

The following detailed description is, therefore, not to be taken in a limiting sense, and the scope of the present disclosure is defined only by the appended claims, along with the full scope of equivalents to which such claims are entitled.

The embodiments of the present invention provide assistance to physically challenged individuals in intimate relations such as sexual intercourse.

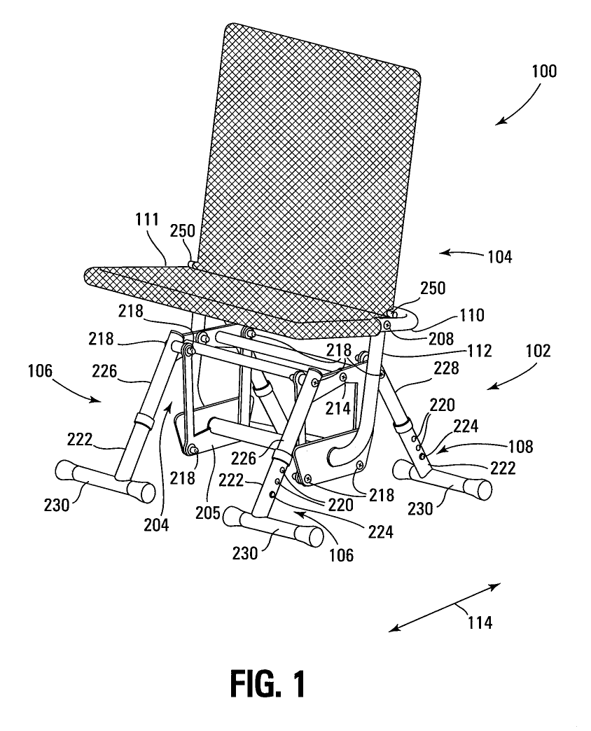

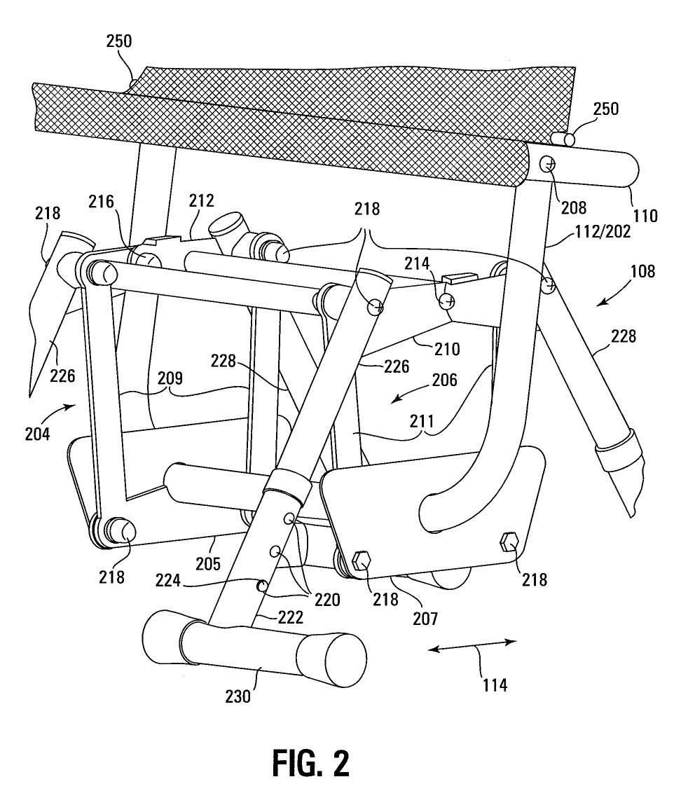

FIGS. 1 and 2 show an embodiment of a glider chair 100 for assisting in sexual intercourse. Chair 100 is on a foldable frame 102 and is storable. The frame 102 supports a seat 104. Frame 102 further includes front and back legs 106 and 108 which are adjustable in height. The seat 104 includes a main support 110 and a back support 112, which in one embodiment are covered by seat cover 111. In one embodiment, seat cover 111 is a single piece that slips over supports 110 and 112 to form the actual seating surface and back support surface for the chair 100. The seat cover in one embodiment is easily removable without disassembly of the chair 100, by folding seat 104 (as described below) to release any tension in the seat cover 111. Easy removal facilitates cleaning or replacement. The seat 104 rocks in a gliding motion substantially horizontally as indicated by arrow 114. The depth of the main seat support 110 is suitably short that while it provides support, the depth is small enough that intercourse can be engaged without undue strain. The depth is suitable to provide clearance for comfortable intercourse.

Referring now also to FIG. 2, additional details of the frame 102 are shown. Seat 104 is supported on frame 102 using a support 202 welded or otherwise affixed to cross member 205 and 207 of four-bar linkages 204 and 206, which also include members 209 and 211. Support 202 is u-shaped in one embodiment, and also forms the frame for back support 112. Seat main support 110 is pivotally attached to support 202 at pivot points 208, and its angle with respect to back support 112 is determined based on stop pins 250. Stop pins 250 in one embodiment are adjustable so that the angle of the main support 110 and the back support 112 is adjustable.

Four-bar linkages 204 and 206 are mounted to folding supports 210 and 212, which fold about points 214 and 216 respectively. The seat 104 glides by the rocking motion of four-bar linkages 204 and 206 about pivot points 218 at the relative top and bottom of the linkages 204 and 206 (eight pivot points in total). Since the cross members 205 and 207 of four-bar linkages 204 and 206 are welded or otherwise attached to the support 202, the seat moves with the same rocking motion as the frame members.

The legs 106 and 108 are attached to the frame members, and on each side of the chair, the front and back legs are pivotally foldably connected at pivot points 214 and 216. Front and back legs 106 and 108 are adjustable in height, in one embodiment with a series of holes 220 in a lower leg member 222 that engage at various locations a pin or other detent mechanism 224 on the main leg members 226 or 228. Each of the legs of the chair is independently adjustable, so that the angle of the chair seat can be adjusted by having the front and rear legs at different heights. This allows accommodation of taller or shorter users, as well as allowing the creation of angles that may be necessary to further facilitate intercourse. Lower leg members in one embodiment have a cross member 230 that is configured to provide lateral support for the chair 100. This provides stability from side to side motion, and assists in maintaining that stability when a user is transferring into the chair from a wheelchair or other seated position.

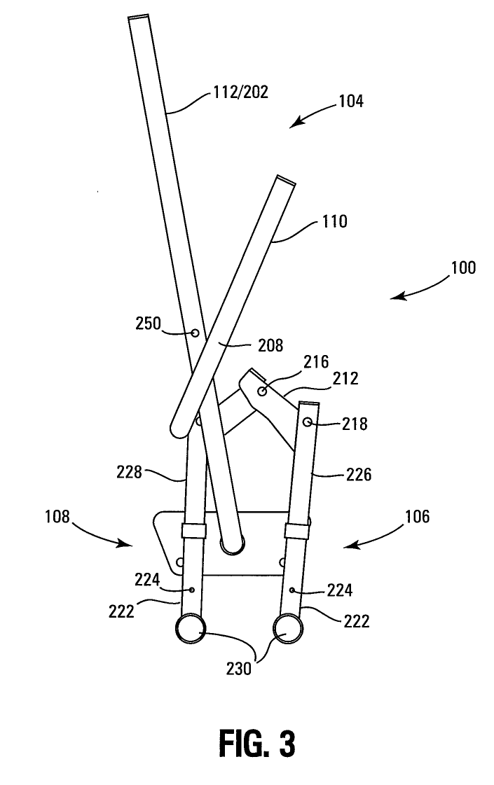

Referring to FIG. 3, a side elevation of an embodiment of chair 100 is shown in a folded position. Main support 110 folds up about pivot point 208, and frame 102 folds up about pivots 216 and 214. In this configuration, the chair 100 is easily stored and is easily portable.

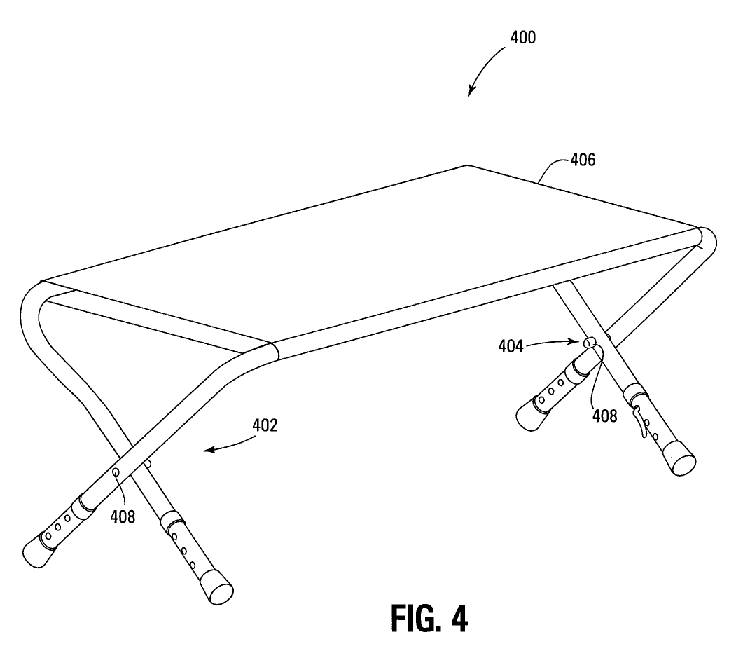

FIG. 4 shows a foldable cot 400 that accompanies the chair 100 in one embodiment, Cot 400 has height adjustable legs 402 and 404 which are adjustable in the same way as the embodiments of the chair 100 described above. Cot cover 406 slides easily on and off of the cot frame when the cot is folded. To fold the cot 400, it is closed about pivot points 408 for easy storage and portability.

The cot 400 and chair are used in operation together or apart. An able bodied partner of a user of the chair can place himself or herself in a nearly endless array of various positions while the chair user remains in a seated position. Rocking motion of the chair 100 is initiated with any easy motion, such as by the user of the chair using his or her hands and arms to create motion, by the user of the chair grasping a partner, or by the partner initiating motion that is imparted to the chair, for example. When desired or necessary, the non-chair using partner uses the cot for support, again in a nearly endless array of further positions. The cot and the chair can be configured at their own angles and heights, creating still another set of configurations to enable nearly any type of intercourse.

Features of the various embodiments of the invention include by way of example only and not by way of limitation, a height appropriate and adjustable height chair with an easy rocking motion that can be initiated with little effort, adjustable angles, an easily removable seat cover and cot cover, and a small and foldable chair and cot that can be easily moved and stored.

A chair for assisting sexual intercourse according to one embodiment comprises a foldable frame having adjustable height legs; a seat having a back support and a main support, the seat glidably supported by the frame to move in a substantially horizontal motion. Further, the main support has a depth in one embodiment suitably small to allow clearance of various body parts to facilitate intercourse. One chair embodiment also has a removable seat pad for the seat, and the seat pad is removable without disassembling the chair.

In another embodiment, a cot is included with the chair or as a separate unit. The cot is on a foldable frame, the frame having adjustable height legs, and includes a cot support pad removably mounted to the frame, and the support pad is removable without disassembling the cot.

### CONCLUSION

A chair for assistance in performing intimate relations, including sexual intercourse, has been described that includes a foldable frame for easy storage. The chair in one embodiment is a glider type chair which rocks in a substantially horizontal motion, has adjustable legs for adjusting height and angle of the chair, and includes a seat pad that is easily removed from the frame without disassembly of the frame. The chair in one embodiment has a main seat support that is suitably shallow to allow for a user to engage in intercourse with a partner not in the chair, so the seat is more shallow in depth that a traditional chair seat in order to facilitate bodily contact and intimacy.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A chair for assisting in intimate relations, comprising:
a frame having adjustable height legs; and
a seat having a back support and a main support, the seat glidably supported by the frame to move in a substantially horizontal motion.

2. The chair of claim 1, wherein the seat has a depth configured to provide support while allowing intercourse without undue strain.

3. The chair of claim 1, and further comprising:
a removable seat pad covering the seat, the seat pad removable without disassembling the chair.

4. The chair of claim 1, wherein each leg is adjustable in height.

5. The chair of claim 1, wherein the chair is foldable for storage.

6. The chair of claim 1, and further comprising:
a cot separate from the chair, the cot comprising a foldable frame having adjustable height legs.

7. The chair of claim 6, wherein the cot further comprises:
a cot support pad removably mounted to the frame.

8. The chair of claim 7, wherein the cot support pad is removable without disassembling the cot.

9. A chair for assisting in intimate relations, comprising:
a foldable frame having adjustable height legs;
a seat having a back support and a main support, the seat glidably supported by the frame to move in a substantially horizontal motion.

10. The chair of claim 9, wherein the main support has a depth configured to allow clearance of body parts past a front of the main support to facilitate intercourse.

11. The chair of claim 9, and further comprising:
a pair of four-bar linkages, each mounted between a front and a back leg of the frame, one four-bar linkage for each side of the frame, the four-bar linkages each having four pivot points for glidable support of the seat.

12. The chair of claim 9, wherein the main support is pivotable between an extended position and a folded position, the seat back support having a pair of pins extending therefrom to engage the main support to maintain the main support in the extended position during use.

13. The chair of claim 9, and further comprising:
a removable seat pad covering the seat, the seat pad removable without disassembling the chair.

14. The chair of claim 9, wherein each leg is adjustable in height.

15. The chair of claim 9, wherein the chair is foldable for storage.

16. The chair of claim 9, and further comprising:
a cot separate from the chair, the cot comprising a foldable frame having adjustable height legs.

17. The chair of claim 16, wherein the cot further comprises:
a cot support pad removably mounted to the frame.

18. The chair of claim 17, wherein the cot support pad is removable without disassembling the cot.
